(19) United States
(12) Patent Application Publication
(10) Pub. No.: US 2024/0146880 A1
(43) Pub. Date: May 2, 2024

(54) AMBIENT COWORKING WITH AVATARS

(71) Applicant: META PLATFORMS, INC., Menlo Park, CA (US)

(72) Inventors: Aryeh Selekman, Washington, DC (US); Thomas Maule, London (GB); Muhammad Adnan Khan, Milton Keynes (GB); Daniel Orth, London (GB)

(21) Appl. No.: 18/453,147

(22) Filed: Aug. 21, 2023

Related U.S. Application Data
(60) Provisional application No. 63/421,610, filed on Nov. 2, 2022.

(51) Int. Cl. H04N 7/15; G06V 40/16

(52) U.S. Cl. CPC H04N 7/157; G06V 40/174

(57) ABSTRACT

Systems and methods for smart communication for providing communication between users showing availability of users via an augmented reality avatar is provided. The system may determine availability by detection of motion and location of a user relative to a device. The system may also determine privacy video calling availability utilizing augmented reality avatars with facial expression tracking. The system may be directed to video communication devices configured for various actions such as, for example, video calling, streaming, gaming, and augmented reality.

### CROSS-REFERENCE TO RELATED APPLICATIONS

This application claims the benefit of U.S. Provisional Application No. 63/421,610 filed Nov. 2, 2022, the entire content of which is incorporated herein by reference.

### TECHNOLOGICAL FIELD

Exemplary embodiments of this disclosure relate generally to methods and apparatuses for smart communication between users.

### BACKGROUND

Various devices and systems have historically enabled users to schedule and hold calls (e.g., video and audio calls or audio only calls) across separate electronic devices. With the increasing use of remote work arrangements, the use of video and audio calls (or video calls) is more prevalent. However, existing methods and apparatuses for video calling may be considered intrusive. For instance, a video call could be intrusive when a recipient at the time of receiving a call has children in the room, has movement in the background, or even the recipient is conscious of their appearances (e.g., having a bad hair day). Remote workers have also been cited as experiencing isolation and video call fatigue. It is important for video call users to feel present while on a video call/meeting but also protect their sense of privacy, as well as, have methods for mitigating fatigue and isolation.

Meaningful relationships have been shown to drive successful collaboration. Flexible work models that combine remote and in-officed work (e.g., hybrid work environments) may be considered disjointed, causing geographically distant workers to have limited visibility to moments outside meetings where people or coworkers may connect. Flexible work arrangements may lack chances for beneficial occurrences between people or coworkers that may add some familiarity with the workplace and foster work relationships. The lack of these chance occurrences or serendipity may lead to feelings of isolation and loneliness of workers, which in turn may negatively impact knowledge workers' sense of belonging, personal productivity, team success, and job satisfaction. The ability for employees to have quick, ad-hoc conversations may build stronger connections and trust within teams.

### BRIEF SUMMARY

Various embodiments are directed to methods and systems for smart communication for providing communication between users showing availability of users via augmented reality (AR) avatars, determining availability by detection of motion and location of a user relative to a device, and privacy video calling availability utilizing AR avatars with facial expression tracking. Various embodiments discussed herein, are directed to video communication devices configured for various actions such as video calling, streaming, gaming, and augmented reality.

In an example, a system may include a user creating a personal avatar; an autonomous user availability tracker; and a facial expression tracker.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 is a diagram of an exemplary network environment in accordance with an exemplary embodiment.

FIG. 2 is a diagram of an exemplary communication device in accordance with an exemplary embodiment.

FIG. 3 is a diagram of an exemplary computing system in accordance with an exemplary embodiment.

FIG. 4 is a diagram of an exemplary video communication device with smart communication capability in accordance with an exemplary embodiment.

FIG. 5 is an exemplary view of the video communication device smart communication interface in accordance with an embodiment.

FIG. 6 illustrates an ongoing call between users on the smart communication interface in accordance with an exemplary embodiment.

FIG. 7 illustrates the smart communication interface personalization settings in accordance with an exemplary embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

It is to be understood that the methods and systems described herein are not limited to specific methods, specific components, or to particular implementations. It is also to be understood that the terminology used herein is for the purpose of describing particular embodiments only and is not intended to be limiting.

In the present disclosure the system is discussed as operable on with a video communication device, but the device may be any electronic device capable of augmented reality systems such a smart phone, smart tablet, a wearable device, Portal device, a desktop PC, or any artificial reality system configured to adjust reality in some manner before presentation to a user (e.g., virtual reality, an augmented reality, a mixed reality, a hybrid reality, Metaverse reality or some combination or derivative thereof).

### Exemplary System Architecture

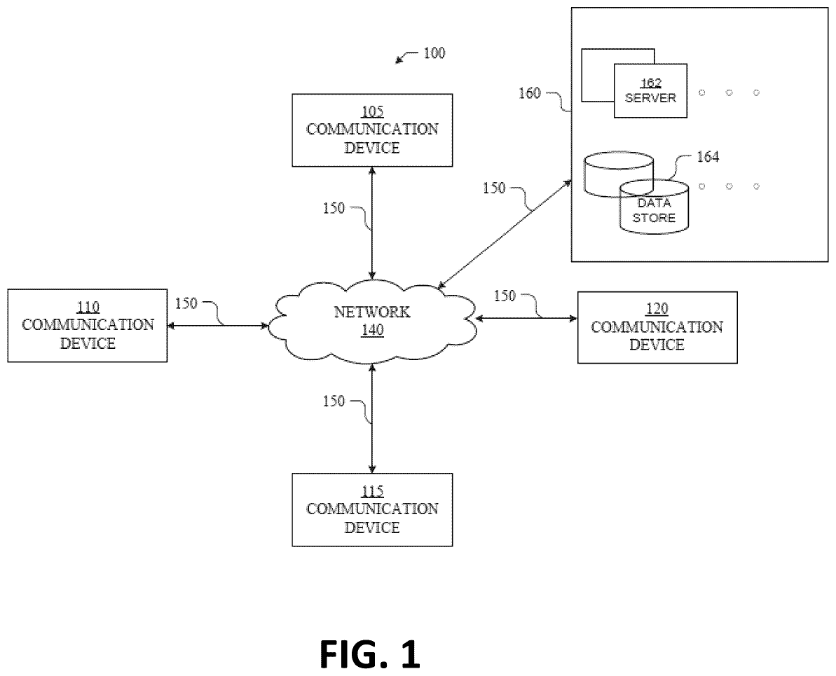

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example, and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example, and not by way of limitation, network device 160 may enable users to interact with each other as well as receive content from other systems (e.g., third-party systems) or other entities, or to allow users to interact with these entities through an application programming interfaces (API) or other communication channels.

It should be pointed out that although FIG. 1 shows one network device 160 and four communication devices 105, 110, 115 and 120 any suitable number of network devices 160 and communication devices 105, 110, 115 and 120 may be part of the system of FIG. 1 without departing from the spirit and scope of the present disclosure.

### Exemplary Communication Device

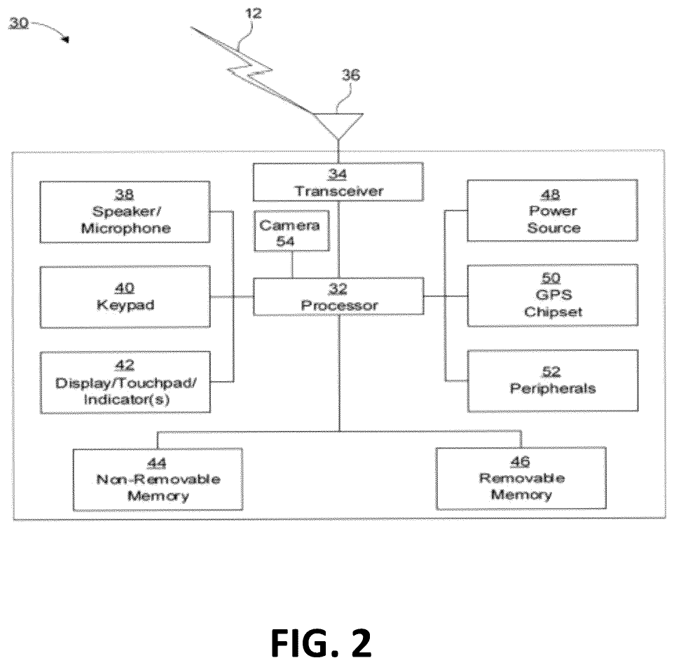

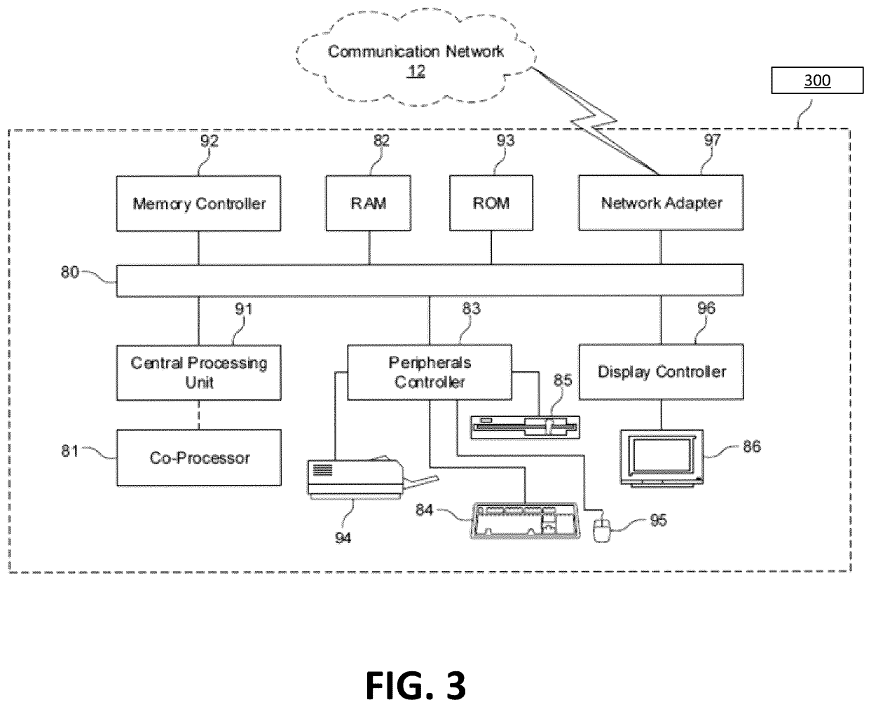

FIG. 2 illustrates a block diagram of an exemplary hardware/software architecture of a communication device such as, for example, user equipment (UE) 30. In some exemplary embodiments, the UE 30 may be any of communication devices 105, 110, 115, 120. In some exemplary embodiments, the UE 30 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 3, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The power source 48 may be capable of receiving electric power for supplying electric power to the UE 30. For example, the power source 48 may include an alternating current to direct current (AC-to-DC) converter allowing the power source 48 to be connected/plugged to an AC electrical receptable and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment. In an example embodiment in which the UE 30 may be a charging case (also referred to herein as carrying case, companion case), the charging case may be a charging case for smart glasses, smart watches and/or other smart devices. The charging case may include one or more microphones (e.g., microphone 38) and wireless functionality built in, to be communicatively coupled and/or paired to smart glasses, smart watches, and/or other smart devices. The charging case may communicate content (e.g., audio, video, images, etc.) to the smart glasses, smart watches and/or other smart devices via one or more signals such as, for example, electromagnetic signals (e.g., a radio frequency signal(s), a Wi-Fi signal(s), a Bluetooth signal(s)) in instances in which the smart watches, smart glasses and/or other smart devices are within the charging case and/or within a proximity (e.g., located a few feet or yards) to the charging case. In some example embodiments, the charging case may have a camera (e.g., camera 54).

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

### Exemplary Computing System

FIG. 3 is a block diagram of an exemplary computing system 300. In some exemplary embodiments, the network device 160 may be a computing system 300. The computing system 300 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 300. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as for example a network adaptor 97, that may be used to connect computing system 300 to an external communications network, such as network 12 of FIG. 2, to enable the computing system 300 to communicate with other nodes (e.g., UE 30) of the network.

### Exemplary Video Communication Device

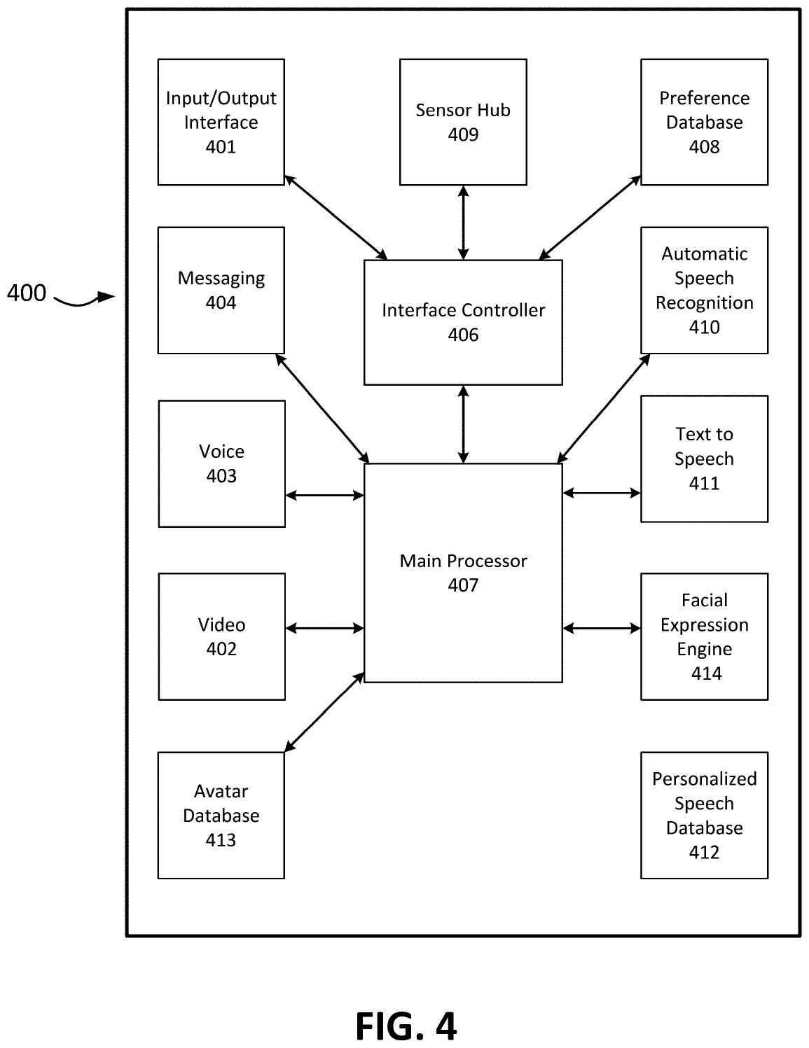

FIG. 4 is an exemplary block diagram that illustrates a video communication device 400 with smart communication capability. Video communication device 400 may contain but is not limited to an input/output interface 401 that may include elements such as a display, a speaker, a microphone, and so forth. Video communication device 400 would also contain various communication resources including video 402, voice 403, and messaging 404. The implementation of the video 402 may involve a video camera and a speaker, the voice 403 may involve a microphone and a speaker, and the messaging 404 may involve a real or virtual keyboard. These communication resources may be transmitted or received via a transmitter or a receiver and stored within a memory. The communication resources may also be stored in a location not native to the video communication device 400 such as a cloud server.

Video communication device 400 may also contain a main processor 407, an automatic speech recognition (ASR) engine 410, a text to speech (TTS) engine 414, a personalized speech database 412, an avatar database 413, and a facial expression engine 414. The ASR engine 410 may convert from a digitized speech as an input into text. The digitized speech and the converted text are not limited to any particular language. The TTS engine 414 may receive a text as an input and convert the text into a synthesized speech as an output. The personalized speech 412 is electrically coupled to the TTS engine 414. TTS engine 414 may be a database containing personal preferences as for how to convert text into speech or speech into text. The avatar database 413 would contain avatars of the user and contacts represented by a still image or a motion image based off user preference. The motion image may be facial expression and lip-synced with the user based off user preference using the facial expression engine 414. Main processor 407 electronically couples the ASR engine 410, the TTS engine 414, the personalized speech database 412, the avatar database 413, and the facial expression engine 414 with the communication resources video 402, voice 403, and messaging 404. Main processor 407 serves as a logical and connective medium during communication.

The Video communication device 400 of FIG. 1 may further contain an interface controller 406, preference database 408, and a sensor hub 409. Interface controller 406 is electrically coupled to the input/output interface 401, main processor 407, preference database 408, and sensor hub 409. The sensor hub 409 may possess one or more sensors such as motion sensors, infrared sensors, temperature sensors, pressure sensors, and so forth. Preference database 408 contains predetermined user preference settings, and those predetermined preference settings may be incorporated along with the sensor hub 409, the time information, and calendar information to be used by the interface controller 406 to determine user availability. When the availability of the user is determined, the interface controller 406 may then coordinate with the preference database 408 and display the availability status of the user to other users or coworkers. Based on user preferences stored in the preference database 408 the interface controller may coordinate with the main processor 407 to facilitate smart communication between users.

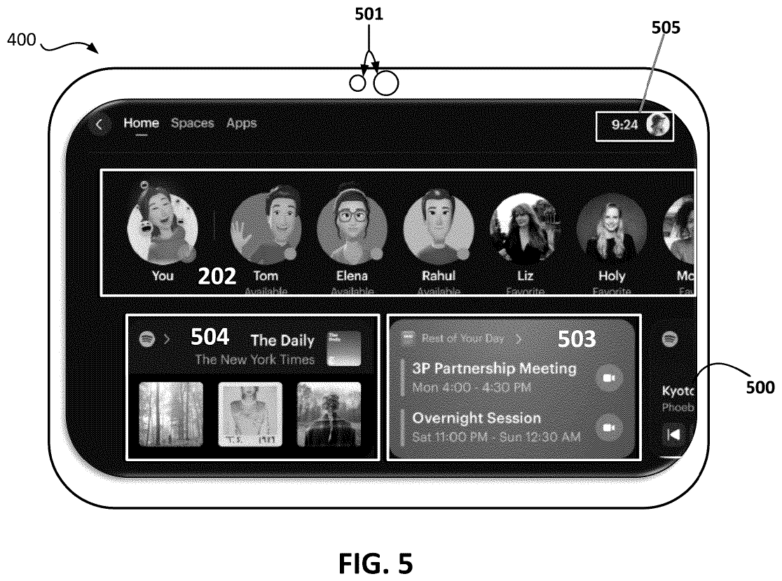

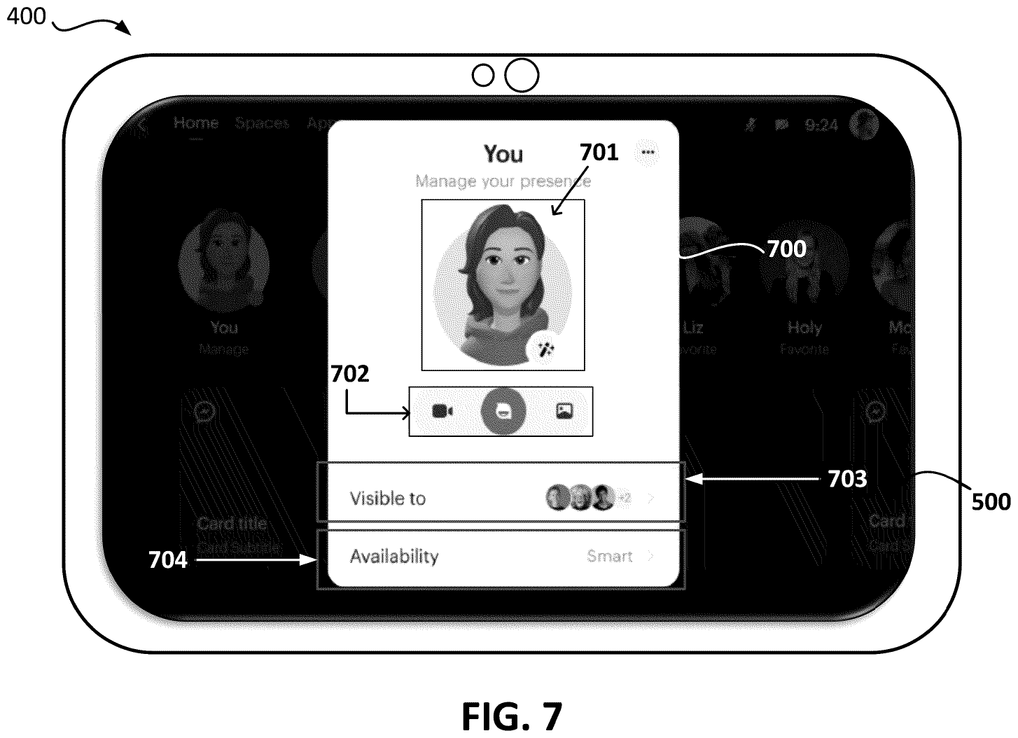

FIG. 5 illustrates an exemplary view of a video communication device 400 smart communication interface. Device 400 contains interface 500 and video camera 501. Interface 500 further comprises availability status 502, calendar 503, widget hub 504, and Time and user photo 505. Availability statuses 502 are shown based on every individual user preference determined by the preference database 408. Based on user individual preference their availability status to others may be shown as a picture, Avatar, blurred live video, or live video accompanied with a colored dot. The color of the dot is based off availability of the user; green for available, yellow for away, and red for busy. Calendar 503 displays to the user upcoming meetings during the day, and alters users' availability based on meetings, i.e., the availability statuses 502 will show that user as busy during a meeting or a call. Widget hub 504 is small application icons for apps determined by user preference. The time and user photo are displayed on the interface 500, where if a user presses the photo, the user can personalize their settings as shown in FIG. 7.

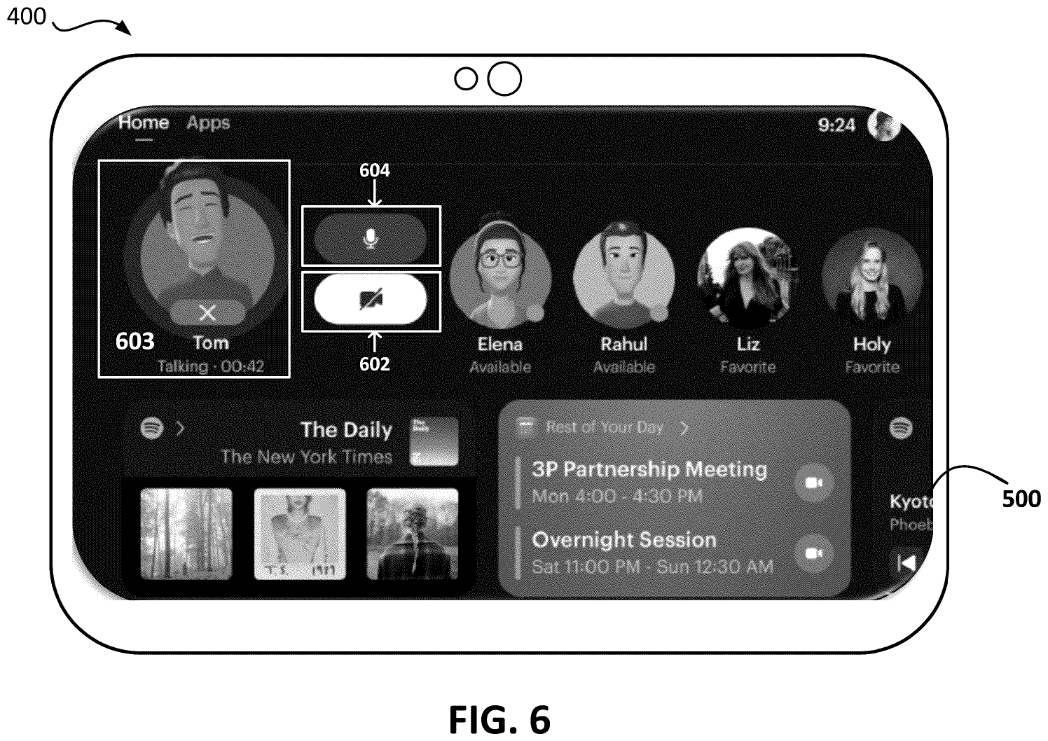

FIG. 6 illustrates an ongoing call between users on the smart communication interface 500. In this example interface 500 further comprises mute button 601, camera control 602, and call in progress 603. Call in progress 603 further comprises an end call button. Mute button 601 is a way to answer calls as well as mute for the user to mute themselves during a call. Camera control 602 may allow for a user to use video camera 501 and show live video during a call. Call in progress 603 shows the elapsed time of a meeting and call receiver facial expressions as captured by the facial expression engine 414, the user may end the call at any time by pressing the end call button.

In this example the user being called is utilizing the avatar feature of the device 400. Main processor 407 allows for this process in conjunction with interface controller 406 utilizing avatar database 413, facial expression engine 414, video 402, and voice 403. The interface controller 406 sends a signal to the main processor 407 that a call is in progress when the call receiver receives a notification of a call and unmutes themselves initiating answering the call and the signal being sent to main processor 407. In response, main processor 407 determines the caller's avatar and facial expressions using the avatar database 413 and facial expression engine 414. Video 402 is then utilized with facial expression engine 414 to capture callers' facial expression to display to call receiver based on user preference. On both ends of the call, receiver and caller, voice 403 is may be used to capture the user who is talking and send that information or signal to the device 400 of the other user on the call.

FIG. 7 illustrates the smart communication interface personalization settings. Interface 500 contains a personalization menu 700. Personalization menu 700 further comprises user avatar 701, view selection 702, visibility list 703, and availability setting 704. Avatar 701 is the user avatar which can be further personalized. View selection 702 enables a user to select how they are viewed by other users via avatar, live video from camera 501, or photo. Visibility list 703 enables the user to see who can see user availability status. Availability setting 704 allows for the user to utilize smart availability tracking or to manually set availability. In this example the user is showing their avatar to others and is utilizing smart availability tracking. Smart availability tracking utilizes main processor 407 in conjunction with sensor hub 409. In this particular embodiment motion sensors may be used to determine whether a user is in front of their device 400. If a user is determined to be in front of device 400, the user may be considered available based on calendar information from interface controller 406.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. An apparatus comprising:
one or more processors; and
at least one memory storing instructions, that when executed by the one or more processors, cause the apparatus to:
provide communication between users showing availability of users via an augmented reality avatar; and
determine the availability by detection of motion and location of a user relative to a device.

2. The apparatus of claim 1, wherein when the one or more processors further execute the instructions, the apparatus is configured to:
determine privacy video calling availability utilizing augmented reality avatars with facial expression tracking.
